(19) United States
(12) Patent Application Publication
(10) Pub. No.: US 2005/0274454 A1
(43) Pub. Date: Dec. 15, 2005

(54) Magneto-active adhesive systems

(76) Inventor: Charles W. Extrand, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/148,950

(22) Filed: Jun. 8, 2005

Related U.S. Application Data
(60) Provisional application No. 60/578,159, filed on Jun. 9, 2004.

(51) Int. Cl. B32B 31/00

(52) U.S. Cl. 156/272.4; 252/62.54; 428/323

(57) ABSTRACT

A magneto-active adhesive and method of adhesive bonding by magnetic field. The method includes steps of providing at least two adherends to be bonded, providing a magneto-active adhesive system between the at least two adherends, the magneto-active adhesive system comprising a plurality of magnetic particles and an adhesive; and applying a non-cyclically varying magnetic field or a cyclically varying magnetic field induced by an alternating current having a frequency of less than 100 hz to the magneto-active adhesive system to change the adhesion of the magneto-active adhesive system to at least one of the adherends. Various carriers for microelectronic devices including magneto-active adhesive contact surfaces are also described within the scope of the invention.

### RELATED APPLICATIONS

This application claims the benefit of U.S. Provisional Patent Application No. 60/578,159, entitled MAGNETO-ACTIVE ADHESIVE SYSTEMS, filed Jun. 9, 2004, hereby fully incorporated herein by reference.

### FIELD OF THE INVENTION

This invention relates to magneto-active adhesive systems that can be activated or modified by a magnetic field and, more specifically, to magneto-active adhesive systems comprising an adhesive and a plurality of magnetic particles.

### BACKGROUND OF THE INVENTION

An adhesive is a substance capable of holding solid materials or adherends together by surface attachment. Adhesives have been widely used since ancient times. Archaeologists have found evidence of a substance being used as an adhesive in Babylon dating back to 4000 B.C. There is also evidence showing that glues were used as a common method of assembly in Egypt between 1500-1000 B.C. The first adhesive patent was issued in about 1750 in Britain for a glue made from fish. Later, patents were issued for adhesives using natural rubber, animal bones, fish, starch, milk protein or casein. Before 1869, the adhesives used in various applications were all natural adhesives, such as glues and natural rubbers. In 1869, the first synthetic adhesive, nitrocellulose, was invented. The development of synthetic adhesives was quickened in the beginning of the 20^{th} century. The development have led to many other synthetic adhesives, such as phenol-formaldehyde resins, polychloroprene, urea-formaldehyde adhesive, nitrile rubber-phenolic adhesives, epoxy resin adhesives, nitrile rubber-epoxy film adhesives, nylon-epoxy film adhesives, isocyanate based adhesives, hot melt adhesives, cyanoacrylate adhesives, anaerobic adhesives, silicone adhesives, high temperature resistant adhesives, hypalon toughened acrylate adhesives, bismaleimide-based adhesives, and acrylated-based or methacrylated-based adhesives.

Adhesives have been applied in many different applications to bond adherends together. The mechanical strength of the adhesive bond is determined by the chemical, physical, and mechanical properties of the adhesive and the adherends, such as surface roughness, wettability, hardness, polarity, temperature, pressure, contact surface area, and viscoelastic properties. The adherends in each application have a unique set of chemical, physical, and mechanical properties, and therefore require certain adhesive characteristics to bonded them together. As a result, many different adhesives have been developed to meet the requirements of various applications.

For many applications, activatable adhesives are desirable, particularly in those applications where a controllable adhesion is required. Some adhesives may be activated by chemicals, such as water (e.g., in glues for stamps), tackifiers, and catalysts or hardeners (e.g., in 2-part epoxy resins). Other adhesives may be activated by electromagnetic radiations or particle beams, such as ultraviolet rays, visible lights, radio frequencies, microwaves, lasers, X rays, and electron beams. There are also adhesives that may be activated by physical changes, such as temperature and pressure. Pressure sensitive adhesives have been widely used in re-positionable applications, such as post-it notes. Depending on the chemical composition, some pressure sensitive adhesives may also be activated by temperature.

In addition to the above-mentioned activatable adhesives, there are magneto-active adhesives and electro-active adhesives which may be activated respectively by a magnetic field or an electric field. In general, the magneto-active adhesive systems disclosed in the prior art include an adhesive and a magnetic inductive material, such as an electrically-conductive material and/or a magnetic material. Such magneto-active adhesive systems are activated mainly by magnetically induced heat generated in the magnetic inductive material by a magnetic field. The magnetically induced heat may arise from eddy current loss and/or hysteresis loss, depending on the magnetic inductive material.

If the magnetic inductive material is an electrically-conductive material, the magnetically induced heat arises mainly from eddy current loss. Eddy current loss is the loss of energy of a cyclically varying magnetic field resulting from its passage through a material in which eddy currents are induced by the cyclically varying magnetic field. The cyclically varying magnetic field may be produced by an induction coil connected to an alternative current power supply. In general, large electrically-conductive materials, such as metals, have large eddy current losses. To reduce or eliminate eddy current losses in some applications, large electrical conductors, such as the metal cores of transformers, are divided into smaller pieces so that large eddies cannot occur. Some electrically-conductive materials are magnetic, such as iron and certain metallic alloys. In addition to eddy current loss, these magnetic and electrically-conductive materials may experience significant hysteresis loss when they are exposed to a cyclically varying magnetic field.

Hysteresis loss is the loss of energy of a cyclically varying magnetic field resulting from its passage through a magnetic material. The magnetic material naturally resists the rapidly changing magnetic fields and generates friction within the magnetic material. The friction produces hysteresis heating, in addition to eddy current heating produced by eddy current loss. Hysteresis heating usually occurs at temperatures below the Curie point of the magnetic material, the temperature at which the magnetic material looses its magnetic properties.

Magnetic induction heating is widely applied in adhesive bonding of metal parts at elevated temperatures in many industrial processes, such as automotive processes for producing clutch plates, brake shoes and auto bumper components. In these applications, the induction heating of metallic parts by a cyclically varying magnetic field melts and/or cures the adhesive to yield a strong and uniform adhesive bonding of the metallic parts. For bonding non-magnetic inductive materials, such as plastics and rubbers, conductive metal susceptors may be used within and/or adjacent to the adhesives for generating and transferring the magnetically induced heat to the adhesives. Magneto-active adhesive systems comprising metal susceptors are widely used in aircraft industry to provide uniform heating to form strong and uniform bonds.

Some methods of bonding adherents with a magneto-active adhesive system, comprising a magnetic inductive material and an adhesive, are mainly based on the applying of a cyclically varying magnetic field to the magnetic inductive material to induce heat to activate the adhesive. There are many drawbacks of such magneto-active adhesive systems. First, the magnetic inductive material has to be large enough to provide sufficient eddy current heating for activating the adhesive. Second, the induction heating rate depends on the frequency of the alternative current for varying the magnetic field. The induction heating rate generally increases with an increase in the frequency. However, high frequencies and thus high induction heating rates are not always available for some applications. For example, low frequencies are required for thick workpieces because high frequencies cannot penetrate deep into the thick workpieces. Third, workpieces that contain magnetic inductive materials and are sensitive to thermal degradation, such as a semiconductor chip or read-write head, may be destroyed by the magnetically induced heat generated by the cyclically varying magnetic field. Fourth, the adhesiveness of the magneto-active adhesive systems in the prior arts may not be rapidly and reversibly adjustable because it takes time for such magneto-active adhesive systems to cool down after they are heated.

The desirable adhesive system, particularly for the microelectronic and semiconductor industries, is one whose degree of adhesion or adhesiveness to an adherend is controllable within an adhesiveness range, and is rapidly and reversibly adjustable between two or more different levels within the adhesiveness range. A rapidly and reversibly adjustable adhesive may reduce contaminations by airborne particles because the adhesiveness of the adhesive system can be turned off when it is not required.

Despite the availability of so many types of adhesives, the adhesive sciences continue to develop to meet new needs and to adapt modern technologies. This disclosure sets forth systems and materials that address these needs.

### SUMMARY OF THE INVENTION

Disclosed herein are magneto-active adhesive systems and also methods of bonding at least two adherends with at least one of the magneto-active adhesive systems. The magneto-active adhesive systems may be activated and/or deactivated reversibly by a magnetic field.

One embodiment features a method of adhesive bonding comprising the steps of:

(a) providing at least two adherends to be bonded;

(b) providing a magneto-active adhesive system between the at least two adherends, the magneto-active adhesive system comprising a plurality of magnetic particles and an adhesive; and

(c) applying a non-cyclically varying magnetic field or a cyclically varying magnetic field induced by an alternating current having a frequency of less than 100 hz to the magneto-active adhesive system to change the adhesion of the magneto-active adhesive system to at least one of the adherends.

Another embodiment features a magneto-active adhesive system comprising a plurality of magnetic particles, an adhesive, and a carrier fluid wherein the carrier fluid and the magnetic particles constitute a magnetorheological fluid.

Another embodiment features a magneto-active adhesive system comprising a plurality of magnetic particles, an adhesive comprising a cross-linked polymer network, and a carrier fluid wherein the carrier fluid, the magnetic particles, and the adhesive constitute a ferrogel.

Another embodiment features a magneto-active adhesive system comprising a plurality of magnetic particles and an adhesive wherein the magnetic particles comprise magnetocaloric particles.

Another embodiment features a magneto-active adhesive system comprising a plurality of magnetic particles and an adhesive wherein the magnetic particles comprise magnetic inductive particles and the adhesive comprises a shape-memory polymer.

A further embodiment features a magneto-active adhesive system comprising a plurality of magnetic particles and an adhesive wherein the magnetic particles comprise encapsulated magnetic particles.

Other features and advantages of the invention will be apparent from the following description of the particular embodiments thereof, and from the claims.

### BRIEF DESCRIPTION OF THE DRAWINGS

FIG. 1 is a fragmentary cross sectional view of two adherends bonded together by a layer of a magneto-active adhesive according to an embodiment of the invention;

FIG. 2 is a fragmentary cross sectional view of two adherends bonded together by a layer of a magneto-active adhesive and with a tie layer bonding the magneto-active adhesive to one of the adherends;

FIG. 3 is a fragmentary cross sectional view of two adherends bonded together by a layer of a magneto-active adhesive with a tie layer and a compatibilizer layer bonding the magneto-active adhesive to one of the adherends;

FIG. 4 is a perspective view of a preferred embodiment of a matrix tray carrier with magneto-active adhesive contact surfaces according to the present invention;

FIG. 5 is a cross sectional view of the carrier of FIG. 4;

FIG. 5A is a fragmentary enlarged view of a portion of FIG. 5;

FIG. 5B is a fragmentary enlarged view of a portion of FIG. 5, depicting an alternative embodiment;

FIG. 5AA is an enlarged view of a portion of FIG. 5A;

FIG. 5BB is an enlarged view of a portion of FIG. 5A depicting mechanical bonding structures for securing the component contact layer to the rigid body portion;

FIG. 5CC is an enlarged view of a portion of FIG. 5A depicting a tie layer for securing the component contact layer to the rigid body portion;

FIG. 5DD is an enlarged view of a portion of FIG. 5A depicting a multiplicity of depressions in the component contact layer for reducing the adhesiveness thereof;

FIG. 5EE is an enlarged view of a portion of FIG. 5A depicting a multiplicity of projections on the component contact layer for reducing the adhesiveness thereof;

FIG. 6 is a cross sectional view of multiple carriers in a stacked configuration;

FIG. 7 is a persective view of an alternative embodiment of a carrier with magneto-active adhesive contact surfaces according to the present invention;

FIG. 8 is a cross-sectional view of the carrier depicted in FIG. 7;

FIG. 9 is a cross sectional view of multiple carriers, as depicted in FIG. 7, in a stacked configuration;

FIG. 10 is a perspective, partially exploded view of a carrier according to FIG. 7 with a separate grid structure for defining individual component retaining regions;

FIG. 11 is a cross-sectional view of the carrier depicted in FIG. 10.

FIG. 12 is a cross sectional view of an alternative embodiment of a carrier with magneto-active adhesive contact surfaces according to the present invention; and

FIG. 13 is a perspective view of a carrier tape with magneto-active adhesive contact surfaces according to an embodiment of the invention.

### DETAILED DESCRIPTION OF PREFERRED EMBODIMENTS

Disclosed herein is a method of adhesive bonding for holding together at least two adherends with a magneto-active adhesive system that can be activated or deactivated reversibly by a magnetic field. The magnetic field may be a non-cyclically varying magnetic field or a cyclically varying magnetic field induced by an alternative current having a frequency that does not cause significant magnetically induced heat generated in the magneto-active adhesive systems of this invention. The magnetically induced heat is significant when it can activate the magneto-active adhesive system. The frequency of the alternative current may be less than 300 hz, preferably less than 100 hz, more preferably less than 50 hz. The magnetically induced heat may also be minimized by using small magnetic particles. In some embodiments, the number average particle size of the magnetic particles may vary from 1000 microns to 1 nm.

As depicted in FIG. 1, a first embodiment of a magneto-active adhesive system 20 generally includes a magneto-active adhesive 22 positioned between a pair of adherends 24 and 26 to hold them together. Magneto-active adhesive 22 generally includes a multiplicity of magnetic particles mixed in an adhesive binder.

The number average particle size of the magnetic particles may vary from 1000 microns to 1 nm. In some embodiments, it varies from 1000 microns to 0.1 micron. In other embodiments, it varies from 100 microns to 10 nm. In further embodiments, it varies from 10 microns to 10 nm. In additional embodiments, it varies from 1 micron to 1 nm. The magnetic particles may be either ferromagnetic or paramagnetic. Ferromagnets are characterized by a high susceptibility, typically between 10⁻² and 10⁶. Paramagnets are characterized by a positive susceptibility and typically of the order of 10⁻⁵ and 10⁻³. Any conventional inorganic, organic or organometallic magnetic particles known in the art may be used for this invention.

Non-limiting examples of inorganic magnetic particles include particles of iron alloys, iron oxides, iron nitride, iron carbide, carbonyl iron, nickel, cobalt, chromium dioxide, stainless steel, silicon steel, neodymium, NdFeBLa, ceramic ferrites, Al—Ni—Fe—Co alloys, and rare-earth magnet materials, and combinations thereof. The inorganic magnetic particles may be modified by surface-treatment with a layer of smaller non-magnetic inorganic particles, such as silica and alumina, or a polymer, such as polystyrene and polyethylene, or a protein, such as avidin, biotin, donkey anti-goat IgG, goat anti-mouse IgG, goat anti-human IgG, protein A, protein G, papain protease, rabbit anti-HA, goat anti-rabbit IgG, sheep anti-rat IgG, streptavidin, γ-globulin, and ferritin. The inorganic magnetic particles also include magnetic particles comprises a non-magnetic core coated partially or completely with smaller inorganic magnetic particles. Some of these coated magnetic particles are described in U.S. Pat. No. 5,091,206, which is incorporated herein by reference.

Non-limiting examples of organic or organometallic magnetic particles include carbon-60 particles, particles of tetracyanoethylene (TCNE) radical anion salts of decamethylferrocene, decamethylmanganocene, and decamethylchromocene, Mn(porphyrin)(TCNE) particles, and particles of polymeric magnets, such as those reported by A. Rajca et el. in “Magnetic Ordering in an Organic Polymer”, Science 2001, 294, pp. 1503-505.

The adhesive binder may be virtually any adhesive material known in the art. Non-limiting examples of suitable adhesive materials include natural rubber, polychloroprene, nitrile rubber-phenolic resins, epoxy resins, nitrile rubber-epoxy resins, nylon-epoxy resins, isocyanate based adhesives, hot melt adhesives, cyanoacrylate, anaerobic adhesives, silicone adhesives, hypalon toughened acrylate adhesives, bismaleimide-based adhesives, polyacrylates, polyvinylether adhesives, silicone rubber adhesives, polyisoprene adhesives, polybutadiene adhesives, styrene-isoprene-styrene block copolymers, polyurethanes, polybutylene terephthalate, polyolefins, polyethylene terephthalate, styrenic block co-polymers, styrene-butadiene rubbers, polyether block polyamides, polypropylene/crosslinked EDPM rubbers, and water-based adhesives such as animal glues, phenol-formaldehyde resins, urea-formaldehyde resins, and latex-based adhesives. The number average molecular weight of the polymeric adhesive materials may vary from 1000 to 10,000,000 daltons.

In some embodiments, magneto-active adhesive 22 generally includes a multiplicity of magnetic particles with a carrier fluid dispersed in an adhesive binder. A mixture of magnetic particles with a carrier fluid is typically known as a magnetorheological (MR) fluid. MR fluids are fluid compositions that respond to an applied magnetic field with a change in rheological behavior. Non-limiting examples of a carrier fluid include water and organic liquids, such as hydrocarbon oils, methanol, ethanol, propanol, dimethyl sulfoxide, dimethyl formamide, ethylene carbonate, propylene carbonate, acetone, tetrahydrofuran, diethyl ether, ethylene glycol, and propylene glycol. The amount of the carrier fluid in the magneto-active adhesive 22 of the present invention may be in the range between about 10 and 80 percent by weight of the total composition.

The magnetic particles in a MR fluid are polarized in the presence of an applied magnetic field, and organized into chains of particles within the carrier fluid. The magnetic particle chains increase the apparent viscosity of the MR fluid. The magnetic particles return to an unorganized state when the magnetic field is removed, which lowers the viscosity of the MR fluid. Typically, the change between the organized and unorganized states caused by a change in the magnetic field is rapid and reversible.

The preparations, properties, and applications of MR fluids have been disclosed in U.S. Pat. Nos. 2,575,360, 2,661,825, 2,667,237, 2,886,151, 4,992,190, 5,043,070, 5,167,850, 5,277,281, 5,284,330, 5,354,488, 5,382,373, 5,398,917, 5,505,880, 5,525,249, 5,547,049, 5,549,837, 5,578,238, 5,598,908, 5,599,474, 5,645,752, 5,670,077, 5,683,615, 5,705,085, 5,804,095, 5,810,126, 5,816,372, 5,845,752, 5,896,965, 5,900,184, 5,906,767, 5,947,238, 5,971,835, 5,985,168, 6,027,664, 6,089,115, 6,095,486, 6,132,633, 6,149,832, 6,158,470, 6,182,954, 6,257,356, 6,260,675, 6,279,700, 6,279,701, 6,279,702, 6,296,088, 6,311,810, 6,318,519, 6,318,520, 6,318,531, 6,318,968, 6,360,856, 6,371,267, 6,390,252, 6,412,761, 6,427,813, 6,428,441, 6,454,674, 6,464,049, 6,475,404, 6,484,566, 6,527,661, 6,527,664, 6,543,396, 6,475,404, 6,547,983, 6,547,986, 6,561,141, 6,561,874, 6,564,618, 6,585,092, 6,592,772, 6,598,465, 6,599,439, 6,611,185, 6,619,444, 6,622,995, 6,637,387, 6,638,443, 6,650,108, 6,681,905, 6,692,650, and 6,702,221. All of the above U.S. patents are incorporated herein by reference. Magnetorheological fluids have been used for controlling damping in various devices, such as dampers, shock absorbers, and elastomeric mounts. They have also been utilized for controlling pressure and/or torque in brakes, clutches, and valves. Nonetheless, there is no disclosure in the prior art regarding the use of magnetorheological fluids in an adhesive.

Any magnetic materials which are known to exhibit magnetorheological activity can be used to prepare the MR fluids for these embodiments. Non-limiting examples of suitable magnetic materials include particles of iron, reduced iron, iron alloys (such as those including aluminum, silicon, cobalt, nickel, vanadium, molybdenum, chromium, tungsten, manganese and/or copper), iron oxides (including Fe₂O₃ and Fe₃O₄), iron nitride, iron carbide, carbonyl iron, nickel, cobalt, chromium dioxide, stainless steel, silicon steel, and a combination thereof. In some embodiments, the magnetic particles are selected form the group consisting of carbonyl iron particles, iron particles, reduced iron particles, iron oxide powder/iron particle mixtures, and iron oxide powder/reduced iron particle mixtures.

The particle size of the magnetic particles in the MR fluid should be large enough for the magnetic particles to exhibit multi-domain characteristics when subjected to a magnetic field. Therefore, the average magnetic particle size in the MR fluid is generally between 0.1 and 1000 microns, preferably between about 0.1 and 500 microns, and more preferably between about 1.0 and 10 microns. The amount of the magnetic particles in the magneto-active adhesive system may be in the range between about 10 and 90 percent by weight of the total composition.

The carrier fluid used in the MR-fluid-based magneto-active adhesive 22 should be compatible with the adhesive binder. When a water-based carrier fluid is used, it is preferred to use a water-based adhesive binder. When an organic liquid is used as the carrier fluid, the adhesive binder used is preferably compatible with the particular organic liquid in the carrier fluid.

Non-limiting examples of water-based adhesives include animal glues, phenol-formaldehyde resins, urea-formaldehyde resins, latex-based adhesives, and those adhesives disclosed in U.S. Pat. Nos. 6,495,628, 6,485,601, 6,440,259, 6,281,298, 6,521,696, 6,495,628, 6,485,601, 6,440,259, 6,281,298, 6,280,515, 6,280,514, 6,238,509, 6,180,244, 6,139,675, 6,087,439, 6,075,078, 5,969,025, 5,962,576, 5,962,564, 5,931,354, 5,821,294, 5,721,302, 5,688,356, 5,686,180, 5,652,299, 5,652,298, 5,652,296, 5,652,288, 5,624,758, 5,523,344, 5,455,293, 5,430,094, 5,395,879, RE34,093, 5,092,953, 5,091,240, 4,853,061, 4,769,401, 4,762,880, 4,762,747, 4,636,546, 4,483,962, 4,396,738, 4,280,942, and 4,240,860. All of the above U.S. patents are incorporated herein by reference.

The adhesive binders that are compatible with organic liquids include, but not limited to, natural rubber, polychloroprene, nitrile rubber-phenolic resins, epoxy resins, nitrile rubber-epoxy resins, nylon-epoxy resins, isocyanate based adhesives, hot melt adhesives, cyanoacrylate, anaerobic adhesives, silicone adhesives, hypalon toughened acrylate adhesives, bismaleimide-based adhesives, polyacrylates, polyvinylether adhesives, silicone rubber adhesives, polyisoprene adhesives, polybutadiene adhesives, styrene-isoprene-styrene block copolymers, polyurethanes, polybutylene terephthalate, polyolefins, polyethylene terephthalate, styrenic block co-polymers, styrene-butadiene rubbers, polyether block polyamides, and polypropylene/crosslinked EDPM rubbers. The amount of the adhesive binder in the magneto-active adhesive 22 may be in the range between about 1 and 80 percent by weight of the total composition.

The adhesiveness of an adhesive (or the degree of adhesion) towards a particular adherend may be measured by any conventional tests of adhesive bonds. Such tests include, but are not limited to, tensile tests (e.g., ASTM D2095-72 and C-297-61 tests), shear tests (e.g, ASTM D1002-01 and D905-49 tests), peel tests (e.g, ASTM D-1781, D903, D1876, and D3167 tests), compression creep test (e.g, ASTM D2293-69 test), tension creep test (e.g, ASTM 2294-69 test), sonic and ultrasonic tests, radiography test, and X-ray test.

The adhesiveness of the MR-fluid-based magneto-active adhesive 22 depends on the adhesiveness of the adhesive binder and the rheological properties of the MR fluid which, in turn, depend on the concentration and density of magnetic particles, particle size and shape distribution, properties of the carrier fluid, additional additives, polarity and strength of the magnetic field, temperature, pH, and other factors. The pH of the aqueous carrier fluid can be modified by the addition of acids or bases. A suitable pH range may be between 5 and 13.

In the absence of a magnetic field, the viscosity, and thus the adhesiveness, of the MR-fluid-based magneto-active adhesive 22 is low. When a magnetic field is applied to the adhesive 22, the viscosity, and thus adhesiveness of the adhesive 22, may be increased to a certain level suitable for some applications, especially for semiconductor and microelectronic applications. If the magnetic field is provided by a permanent magnet, the strength of the magnetic field, and thus the adhesiveness, can be controlled by adjusting the mechanical position of the permanent magnet relative to the adhesive 22, either manually or automatically. If the magnetic field is provided by a DC electromagnet, the adhesiveness can be controlled by the magnitude of the DC current passing through the coil of the DC electromagnet. If the magnetic field is provided by an AC electromagnet, the adhesiveness will vary with the polarity and strength of the cyclically varying magnetic field. This cyclical variation in the adhesiveness may be an advantage if the change in the adhesiveness is synchronized with an automated bonding-debonding process. The adhesiveness of the MR-fluid-based magneto-active adhesive 22 may also be adjusted by the concentration, density, particle size, and shape distribution of the magnetic particles, properties of the carrier fluid, temperature, pH, and additional additives, such as fillers, rheology modifiers, anti-static agents, surfactants, dispersing agents, antioxidants, coupling agents, curing agents, and combinations thereof.

In other embodiments of this invention, the magneto-active adhesive 22 generally includes a carrier fluid and an adhesive binder that is a cross-linked polymer network. The adhesive binder, the magnetic particles, and the carrier fluid together constitute a ferrogel. A ferrogel is a cross-linked polymer network swollen by a ferrofluid. A ferrofluid is a two-phase system, comprised of small magnetic particles dispersed in a liquid. The number average particle size of the magnetic particles is between about 1 and 1000 nm. Although ferrogels have been applied in various applications, such as soft actuators, micromanipulators, artifcial muscles, cancer therapy, and immunoblotting, there is no report in the prior art regarding the use of ferrogels in adhesive applications.

In the ferrogel, the finely distributed magnetic particles are located in the ferrofluid and attached to the cross-linked polymer network by adhesive forces. In the absence of a magnetic field, the magnetic moments of the magnetic particles are randomly oriented, and thus the gel has no net magnetization. As soon as a magnetic field is applied, the magnetic moments tend to align with the magnetic field to produce a bulk magnetic moment. With ordinary magnetic field strengths, the tendency of the dipole moments to align with the applied field is partially overcome by thermal agitation. As the strength of the magnetic field increases, all the particles eventually align their magnetic moments along the direction of the magnetic field, and as a result, the magnetization saturates. If the magnetic field is turned off, the magnetic dipole moments quickly randomize and thus the bulk magnetization is again reduced to zero.

The preparation and characterization of ferrogels are disclosed in M. Zrinyi, “Magnetic-field-sensitive gels,” Trends in Polymer Science, Vol. 5, No. 9, pp. 280-285 (1997); Zrínyi et el., “Magnetic Field Sensitive Polymeric Actuators,” in Y. Osada and D. E. Rossi (ed.), Polymer Sensors and Actuators, Heidelberg, Springer-Verlag Berlin, 385-408 (1999); Zrínyi et el., “Comparative Studies Of Electric-And Magnetic Field Sensitive Polymer Gels Smart Structures And Materials,” in Yoseph Bar Cohen (ed.), Electroactive Polymer Actuators and Devices, SPIE, 1999/3669: 406-413; Zrínyi et el., “Electric and Magnetic Field-Sensitive Smart Polymer Gels,” in Y. Osada and A. Khokhlov (ed.), Polymer Gels and Networks, New York, Marcel Dekker, Inc., 309-355 (2001), M. Zrínyi, “Intelligent Polymer Gels Controlled by Magnetic Fields,” Colloid & Polymer Science, Vol. 27 (2), 98-103 (2000); Xulu et el., “Preparation and Responsive Properties Magnetically Soft Poly(N-isopropylacrilamide) Gels,” Macromolecules, 33(5) 1716-1719 (2000), all of which are incorporated herein by references.

Ferrogels may be prepared by precipitating well-dispersed magnetic particles in a polymeric material, before, during, or after the cross-linking of the polymeric material to form a polymer network. Alternatively, ferrogels may be prepared by making the colloidal magnetic particles separately, and then by cross-linking the polymeric material after a solution of the polymeric material and the magnetic sol are mixed together. Non-limiting examples of suitable cross-linked polymer network include cross-linked poly(vinylalcohol) hydrogels, poly(N-isopropylacrilamide) gels, gels containing poly(acrylamide) and poly(acrylic acid), poly(vinyl methyl ether) gels, polysaccharide gels, gels containing a copolymer of methacryloyloxyethyltrimethylammonium and N-isopropylacrylamide, poly(acrylamide) gels, and poly(methacrylamide) gels. The amount of the cross-linked polymer network in the ferrogels may vary between 20 wt % to 90 wt %.

The magnetic particles may be magnetite particles prepared form a magnetite (Fe₃O₄) sol. The magnetite sol may be prepared from FeCl₂ and FeCl₃ in aqueous solution. The stability of the magnetite sol may be maintained by a small amount of peptizing agent, such as acetic acid, hydrochloric acid, formic acid, hydrobromic acid, hydroiodic acid, hydrofluoric acid, hydroperchloric acid, polycarboxylic acids, and nitric acid. The size of the magnetite particles may vary between about 1 and 1000 nm. The amount of the magnetite particles in the ferrogels may vary between 1 wt % to 80 wt %.

The carrier fluid may be water or an organic liquid, such as hydrocarbon oils, methanol, ethanol, propanol, dimethyl sulfoxide, dimethyl formamide, ethylene carbonate, propylene carbonate, acetone, tetrahydrofuran, diethyl ether, ethylene glycol, and propylene glycol. The amount of the carrier fluid in the ferrogel-based magneto-active adhesive 22 may be in the range between about 10 and 80 percent by weight of the total composition.

The properties of ferrogels may depend on the preparation conditions (solvent, concentration of cross-linking, concentration of magnetic particles). Because the magnetic particles are attached to the cross-linked polymer network, forces acting on the magnetic particles are transmitted directly to the polymer network resulting in the deformation of the polymer network. If the magnetic field is strong enough, the deformation of the polymer network may lead to reversible changes in macroscopic shape and adhesiveness. The magnetic field may be provided by a permanent magnet, a DC electromagnet, or an AC electromagnet powered by an AC having a frequency less than 300 hz. The adhesiveness of ferrogel-based magneto-active adhesive 22 may be further modified by concentration of cross-linking, concentration of magnetic particles, and additional additives, such as fillers, rheology modifiers, tackifiers, anti-static agents, surfactants, dispersing agents, antioxidants, coupling agents, curing agents, and combinations thereof.

In other embodiments of this invention, the magnetic particles in the magneto-active adhesive 22 are magnetocaloric particles. Magnetocaloric materials are magnetic materials that heat up when they are placed in a magnetic field and cool down when they are removed from a magnetic field. The size of the effect has been typically around 0.5 to 5° C. per Tesla change in magnetic field. Any known magnetocaloric materials in the art may be used for these embodiments. Some non-limiting examples of magnetocaloric materials include gadolinium, MnAs, La(Fe_{0.88}Si_{0.12})₁₃, La(Fe_{0.88}Si_{0.12})₁₃H_{1.0}, alloys of gadolinium, germanium and silicon, such as Gd₅Si₂Ge₂. The amount of the magnetocaloric particles in the magnetocaloric-based magneto-active adhesive system may be in the range between about 10 and 90 percent by weight of the total composition.

As discussed above, the mechanical strength of the adhesive bond is determined by wettability, hardness, and viscoelastic properties of the adhesive. Therefore, when the temperature of an adhesive is increased or decreased, the wettability, hardness, and viscoelastic properties of the adhesive of the adhesive may be increased or decreased respectively, particularly when the change in temperature causes a physical transition of the adhesive, such as a melting transition, a freezing transition, a softening transition, and a glass transition. Therefore, by applied a magnetic field, the temperature, and thus the adhesiveness, of the magnetocaloric-based magneto-active adhesive 22 may be increased, particularly when the change in temperature causes a melting transition, a softening transition, or a glass transition. When the magnetic field is removed, the temperature, and thus the adhesiveness, of the magnetocaloric-based magneto-active adhesive 22 may be decreased, particularly when the change in temperature causes a freezing transition or a glass transition. If the magnetic field is provided by a permanent magnet, the strength of the magnetic field, and thus the adhesiveness, can be controlled by adjusting the mechanical position of the permanent magnet relative to adhesive 22, either manually or automatically. If the magnetic field is provided by a DC electromagnet, the adhesiveness can be controlled by the magnitude of the DC current passing through the coil of the DC electromagnet. The adhesiveness of the magnetocaloric-based magneto-active adhesive 22 may also be adjusted by the concentration, density, particle size and shape distribution of the magnetocaloric particles, temperature, and additional additives, such as fillers, rheology modifiers, tackifiers, anti-static agents, surfactants, dispersing agents, antioxidants, coupling agents, curing agents, and combinations thereof.

Any conventional adhesive binder known in the art may be used for the magnetocaloric-based magneto-active adhesive 22. Non-limiting examples of suitable adhesive binders for the magnetocaloric-based magneto-active adhesive 22 include polyurethanes, polybutylene terephthalate, polyolefins, polyethylene terephthalate, styrenic block co-polymers (e.g. Kraton®), styrene-butadiene rubber, nylon in the form of polyether block polyamide, thermoplastic vulcanizate materials, such as polypropylene/crosslinked EDPM rubbers. The amount of the adhesive binder in the magnetocaloric-based magneto-active adhesive 22 may be in the range between about 10 and 90 percent by weight of the total composition.

In some embodiments, the adhesive binder in the magnetocaloric-based magneto-active adhesive 22 optionally may comprise a side-chain crystallizable polymer. The side-chain crystallizable polymer may include as a main component thereof an acrylic acid ester and/or methacrylic acid ester which has a straight-chain alkyl group including 12 or more carbon atoms as a side-chain. Non-limiting examples of such side-chain crystallizable polymers are described in U.S. Pat. Nos. 6,666,752 and 5,886,067, both of which are incorporated herein by reference. The amount of the side-chain crystallizable polymer may be between about 1% to about 99% by weight based on the adhesive composition.

In other embodiments of this invention, the magnetic particles in the magneto-active adhesive 22 are particles of at least a magnetic inductive (or susceptive) material and the adhesive comprises a shape-memory polymer (SMP) or a side-chain crystallizable polymer. A magnetic inductive material may be an electrically-conductive material and/or a magnetic material that may be heated by a cyclically varying magnetic field. Some magnetic inductive materials are disclosed in U.S. Pat. Nos. 6,639,197, 5,916,469, 5,717,191, 5,500,511, 4,123,305, and 3,996,402, all of which are incorporated herein by reference.

The SMPs are polymers that exhibit a shape-memory effect. In general, the SMPs are chemically characterized as phase segregated linear block co-polymers having a hard segment and a soft segment. The hard segment is typically crystalline with a defined melting point, and the soft segment is typically amorphous with a defined glass transition temperature. In some embodiments, however, the hard segment is amorphous and has a glass transition temperature rather than a melting point. In other embodiments, the soft segment is crystalline and has a melting point rather than a glass transition temperature. Generally, the melting point or glass transition temperature of the soft segment is substantially less than the melting point or glass transition temperature of the hard segment.

When an SMP is heated above the melting point or glass transition temperature of the hard segment, the SMP can be shaped permanently. This permanent shape can be memorized by cooling the SMP below the melting point or glass transition temperature of the hard segment. When the permanently shaped SMP is cooled below the melting point or glass transition temperature of the soft segment while the permanent shape is deformed to form a temporary shape, the temporary shape is fixed. The permanent shape is recovered by heating the SMP above the melting point or glass transition temperature of the soft segment but below the melting point or glass transition temperature of the hard segment. In another method for setting a temporary shape, the SMP is deformed at a temperature lower than the melting point or glass transition temperature of the soft segment, resulting in stress and strain being absorbed by the soft segment. When the SMP is heated above the melting point or glass transition temperature of the soft segment, but below the melting point (or glass transition temperature) of the hard segment, the stresses and strains are relieved and the SMP returns to its permanent shape. The recovery of the permanent shape, which is induced by heat, is called the shape-memory effect.

When the soft segments of the SMPs undergo a melt or glass transition, some of the physical properties of the SMPs, such as elastic modulus, hardness, and adhesiveness (or tackiness) may be changed significantly. The elastic modulus of some SMPs may be changed by a factor of up to 200 when heated above the melting point or glass transition temperature of the soft segment. Similarly, the hardness of some SMPs may be changed dramatically when the soft segment is at or above its melting point or glass transition temperature. The permanent and temporary shape of the SMPs may be designed or programmed such that a transition from a permanent shape (or temporary shape) to a temporary shape (or permanent shape) may cause an increase or a decrease in contact surface area between the SMP-based magneto-active adhesive system and the adherends. Since the adhesiveness of the SMPs depends on their elastic modulus, hardness, and contact surface area with the adherends, the adhesiveness of the SMP-based magneto-active adhesive system may be controlled electrically by changing their temperature by heating the susceptor particles in the system with a magnetic field.

In some embodiments of interest, the SMP is a copolymer based on oligo(ε-caprolactone) dimethacrylate and n-butyl acrylate, commercially available from mnemoScience (Aachen, Germany, http://www.mnemoscience.de/) or VERIFLEX™ shape memory polymer systems, commercially available from Cornerstone Research Group, Inc. (Dayton, Ohio, http://www.crgrp.net/veriflex.htm). The physical properties of the copolymer of oligo(ε-caprolactone) dimethacrylate and n-butyl acrylate, such as the tackiness, cross-link density, and transition temperature, may be adjusted by varying the relative amounts of oligo(ε-caprolactone) dimethacrylate and n-butyl acrylate in the copolymer.

Other non-limiting examples of SMPs include special blends of two or more polymers selected from the group consisting of polynorborene-based polymers, polyisoprene-based polymers, polystyrene butadiene-based polymers, and polyurethane-based polymers, vinyl acetate-based polymers, and polyester-based polymers. Some of these SMP's are described in Kim, et al., “Polyurethanes having shape memory effect,” Polymer 37(26):5781-93 (1996); Li et al., “Crystallinity and morphology of segmented polyurethanes with different soft-segment length,” J. Applied Polymer 62:631-38 (1996); Takahashi et al., “Structure and properties of shape-memory polyurethane block copolymers,” J. Applied Polymer Science 60:1061-69 (1996); Tobushi H., et al., “Thermomechanical properties of shape memory polymers of polyurethane series and their applications,” J. Physique IV (Colloque C1) 6:377-84 (1996); U.S. Pat. Nos. 5,506,300; 5,145,935; 5,665,822; and Gorden, “Applications of Shape Memory Polyurethanes,” Proceedings of the First International Conference on Shape Memory and Superelastic Technologies, SMST International Committee, pp. 115-19 (1994). All of the above references are incorporated herein by reference.

The preparations, properties, and applications of SMP have also been disclosed in Lendlein et al., “Shape-Memory Polymers,” Encyclopedia of Polymer Science and Technology, Vol. 4, Third Edition, Wiley Publishers (2003); Lendlein et al., “Shape-Memory Polymers,” Angew. Chem. Int. Ed., 41(12), Pages 2034-2057 (2002); Lendlein et al., “AB-Polymer Network Based On Oligo(ε-Caprolactone) Segments Showing Shape-Memory Properties,” Proc. Natl. Acad. of Sci. USA, Vol. 98(3), p. 842 (2001); and U.S. Pat. Nos. 6,720,402, 6,388,043, 6,370,757, 6,293,960, 6,224,610, 6,160,084, 6,102,933, 6,102,917, 6,086,599, 5,957,966, 5,910,357, 5,189,110, 5,128,197, 5,093,384, 5,049,591, 5,043,396, and 4,945,127. All of the above references are incorporated herein by reference.

As mentioned above, when there is a change in temperature causing a transition in the soft segments of the SMP, the contact surface area and/or the tackiness of the SMP-based magneto-active adhesive system may be increased or decreased by turning on or off a magnetic field. The adhesiveness of the SMP-based magneto-active adhesive 22 may also be adjusted by the concentration, density, particle size and shape distribution of the magnetic inductive particles, temperature, and additional additives, such as fillers, rheology modifiers, tackifiers, anti-static agents, surfactants, dispersing agents, antioxidants, coupling agents, curing agents, compatibilizers, plasticizers, and combinations thereof.

In additional embodiments of this invention, the magnetic particles in the magneto-active adhesive system are encapsulated with a material that is either more adhesive or less adhesive than the adhesive in the magneto-active adhesive 22. The adhesiveness of a material for these embodiments may be determined by any of the tests of adhesive bonds mentioned earlier. When a material that is more (or less) adhesive than the adhesive in the magneto-active adhesive system is used, the adhesiveness of the encapsulation-based magneto-active adhesive system may be increased (or decreased) reversibly by a magnetic field.

Any strong adhesive known in the art may be used as a more adhesive material for encapsulating the magnetic particles in these embodiments. Non-limiting examples of strong adhesives are epoxy resins, nitrile rubber-epoxy resins, nylon-epoxy resins, isocyanate based adhesives, cyanoacrylate, silicone adhesives, polyacrylates, and polyvinylether adhesives.

The less adhesive materials for encapsulating the magnetic particles may be materials having a lower solubility parameter or a lower surface energy than those of the adhesive in the encapsulation-based magneto-active adhesive system. There is a positive correlation between Hildebrand solubility parameter and the surface energy. In general, a material having a high (or low) Hildebrand solubility parameter tends to have a high (or low) surface energy. In some embodiments, the less adhesive materials have a Hildebrand solubility parameter less than 10 MPa^{1/2}. The Hildebrand solubility parameters of some polymers are disclosed in Patrick, “Treatise on Adhesion and Adhesives Vol. 1,” Marcel Dekker, New York, 1967, which is incorporated herein by reference. In other embodiments, the less adhesive materials have a surface energy less than 50 dynes/cm. The measurement of the surface energy of polymers have been disclosed in S. Wu, “Polymer Interface and Adhesion,” Chapter 5, pp. 169-211, Marcel Dekker, New York, 1982, which is incorporated herein by reference. In further embodiments, the less adhesive material may be selected from the group consisting of polyethylene, polypropylene, poly(methyl methacrylate), poly(vinyl acetate), poly(vinyl chloride), polystyrene, poly(tetrafluororethylene), ester gum, silicones, and rubbers, such as butadiene-acrylonitrile, butadiene-styrene, cis-polyisoprene, polychloroprene, polybutadiene, polyisobutylene, copolymers of ethylene and propylene, and polysulfides.

The magnetic particles that are encapsulated with a more adhesive material are designated thereafter as sticky encapsulated particles and the magnetic particles that are encapsulated with a less adhesive material are designated thereafter as non-sticky encapsulated particles. The adhesiveness of the encapsulation-based magneto-active adhesive system may be increased or decreased by moving the sticky or non-sticky encapsulated particles by a magnetic field to contact with or clear from the surface of the adherend. When an increase in adhesiveness is desired, sticky particles may be moved to contact with the surface or non-sticky particles may be moved out of the surface by a magnetic field. When a decrease in adhesiveness is desired, non-sticky particles may be moved to contact with the surface or sticky particles may be moved out of the surface by a magnetic field. If the magnetic field is provided by a permanent magnet, the strength of the magnetic field, and thus the adhesiveness, can be controlled by adjusting the mechanical position of the permanent magnet, either manually or automatically. If the magnetic field is provided by a DC electromagnet, the adhesiveness can be controlled by the magnitude of the DC current passing through the coil of the DC electromagnet. If the magnetic field is provided by an AC electromagnet, the adhesiveness will vary with the polarity and strength of the cyclically varying magnetic field. This cyclically varying adhesiveness may be an advantage if the change in the adhesiveness is synchronized with an automated bonding-debonding process. The adhesiveness of the encapsulation-based magneto-active adhesive system may be adjusted by the concentration and density of magnetic particles, particle size and shape distribution, properties of the encapsulating materials, temperature, and additional additives, such as fillers, rheology modifiers, tackifiers, anti-static agents, surfactants, dispersing agents, antioxidants, coupling agents, curing agents, and combinations thereof.

Encapsulated magnetic particles may be prepared by any conventional encapsulation techniques for encapsulating small particles. In some embodiments, the encapsulating material is dissolved in a solvent to form a solution. The magnetic particles are encapsulated by dispersing them in the solution. The encapsulated magnetic particles may be filtered from the solution and dried by any conventional drying equipment, such as desiccators, spray driers, rotary evaporators, convention ovens, vacuum ovens, convection ovens, infra-red ovens, and microwave ovens. Alternatively, the magnetic particles may be surface-treated with a compound having a polar end (e.g., a carboxyl group, a hydroxyl group, a thiol group, a sulfate group, a sulfonate group, a phosphate group, a phosponate group, amine groups, and quaternary ammounium groups) and a hydrophobic group (e.g., an alkyl group, an alkenyl group, an alkynyl group, an alkaryl group, an ether group, and an ester group). The surface-treated magnetic particles are suspended in water with a polymerizable organic monomer that is immiscible with water. The molecules of the polymerizable organic monomer are naturally attracted to the treated surfaces of the magnetic particles and are polymerized to form a shell encapsulating the magnetic particles. Other encapsulating techniques for small particles, particularly magnetic particles, are disclosed in Phanapavudhikul et el., “Para-Magnetic Composite Microparticles As Heavy Metal Ion-Exchangers,” European Cells and Materials Vol. 3. Suppl. 2, pp. 118-121 (2002), Chatterjee et el., “Synthesis Of Polyethylene Magnetic Nanoparticles,” European Cells and Materials Vol. 3. Suppl. 2, pp. 98-101 (2002), and Chatterjee et el., “Biodegradable magnetic gel: synthesis and characterization,” Colloid & Polymer Science, Volume 281, Number 9, pp. 892-896. All of which are incorporated herein by reference.

Activation and deactivation of adhesive 22 may be accomplished with any of a variety of magnetic field producing devices. A non-cyclically varying magnetic field may be provided by a permanent magnet. Any conventional permanent magnets known in the art, such as ceramic ferrites, alnico magnets, and rare-earth magnet materials, may be used for this invention. Ceramic ferrites are made from fine iron oxide powders by powder metallurgical methods. Alnico magnets are elongated magnetic particles that are precipitated throughout the matrix of an Al—Ni—Fe—Co alloy during the manufacturing process. Non-limiting examples of rare-earth magnet materials include Nd₂Fe₁₄B, NdFeB, and alloys of SmCo, such as SmCo₅ and Sm₂Co₁₇. The above-mentioned and other permanent magnet materials are described by P. Campbell in “Permanent Magnet Materials and their Application,” Cambridge University Press, reprint edition (1996), which is incorporated herein by reference.

The magnetic field may also be provided by an electromagnet comprising a coil of electrically-conductive wire. The magnetic field is induced by an electric current flowing through the coil. The magnetic field disappears when the flow of electricity is stopped. In general, electromagnets are classified into two categories: DC (direct-current) and AC (alternating-current). The DC electromagnets provide a non-cyclically magnetic field with variable strength. The AC electromagnets provide a cyclically varying magnetic field. It is preferred that the frequency of the AC current is low enough so that it does not cause significant magnetically induced heat generated in the magnetic particles to activate the magneto-active adhesive systems of this invention.

Electromagnets have at least two advantages over permanent magnets. First, the magnetic field provided by electromagnets can be switched on and off, or reversed, or its strength varied, by controlling the electric current. Permanent magnets require mechanical means for magnetic field adjustments, whereas the magnetic fields provided by electromagnets can be changed rapidly and reversibly by simply adjusting the polarity and/or the magnitude of the input current. Second, an electromagnet can generate a stronger magnetic field than a permanent magnet of similar size and weight.

The simplest electromagnets have the air-core configuration. The air-core electromagnets typically consist of either a freestanding copper coil, or a copper coil mounted on non-magnetic, non-conductive media. The relatively low inductance of the air-core electromagnets makes them well suited for applications requiring low magnetic field strengths and high frequency inputs. Consequently, air-core electromagnets are used mainly for AC electromagnets, and rarely for DC electromagnets.

Where a strong and continuous magnetic field is required, a high permeability ferrous core (magnetic conductor) may be placed into the electromagnet. The selection of core material is based upon input and remanent field requirements of the application. Non-limiting examples of core materials include cold rolled steels, electrical steels, and high saturation magnetic steels. Most DC electromagnets with a core can provide significant increases in field strength over the air-core electromagnets. However, the core materials do exhibit a significant remainent value in their hysterisis curve. Consequently, a non-zero field magnitude may result even after power has been removed from the inputs.

AC electromagnet cores may require consideration of a few additional characteristics. Unlike DC electromagnet cores, the AC electromagnet cores are prone to eddy-current and hysterisis losses because the magnetic inductive core materials are in a cyclically varying magnetic field. The eddy current loss can be minimized by the use of powdered irons, ferrites, and laminated structures. The frequency and field magnitude are relevant to the proper selection of a core material. There is always resistive heating in the coils of both DC and AC electromagnets. If current densities in the coils are excessive, a forced means of cooling may be required to remove the excess resistive heat and to prevent the performance of the electromagnets form deterioration. Forced convection and water-cooling are the two most common methods of cooling electromagnets. Various electromagnets are described by A. N. Mansfield in “Electromagnets: Their Design, and Construction,” Wexford College Press, (2002), which is incorporated herein by reference.

The current flowing through the coil of an electromagnet may be provided by a power supply. The power supply sends either a DC or AC current through the coil to produce a magnetic field around the workpiece. Power supplies for electromagnets can are available from commercial suppliers, such as Lake Shore Cryotronics, Inc., Westerville, Ohio; Industrial Magnetics, Inc., Boyne City, Mich.; Glassman High Voltage, Inc., High Bridge, N.J.; and Bunting Magnetics Co., Newton, Kans.

For induction heating applications, such as those magneto-active adhesive systems in the prior arts, the frequency of the AC power supply usually varies from 4 kHz to 500 kHz. The induction heating is significant when the frequency is above 4 khz. Fortunately, the induction heating rate generally decreases with a decrease in frequency. When the frequency drops down to 300 hz, the induction heating is not significant. Therefore, for some embodiments of this invention, a frequency below 300 hz is used to prevent the production of a significant amount of magnetically induced heat. In other embodiments, the frequency is below 100 hz. In further embodiments, the frequency is below 50 hz. In some embodiments, the frequency is below 10 hz. In additional embodiments, the frequency is below 1 hz.

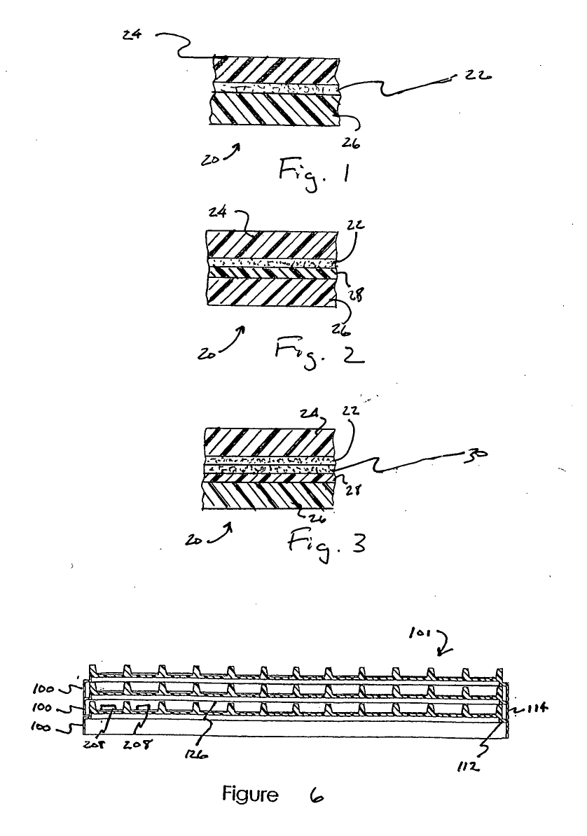

As depicted in FIG. 2, magneto-active adhesive system 20 may further include a conventional adhesive or tie layer 28 positioned between adherend 26 and magneto-active adhesive 22 to improve adhesion between magneto-active adhesive 22 and adherend 26. It will be appreciated that layer 28 may be positioned between magneto-active adhesive 22 and either or both adherends 24, 26, as desired.

Moreover, as depicted in FIG. 3, a compatibilizer layer 30 may be provided between tie layer 28 and magneto-active adhesive 22 to improve adhesion therebetween. Compatibilizer layer 30, which is preferably selected so as to be compatible with both the tie layer 28 and magneto-active adhesive 22, may include a polymeric material such as block co-polymers and graft co-polymers.

The magneto-active adhesive 22 systems of this invention are versatile because they encompass a wide range of constructions and compositions. They are particularly suitable for those applications require controllable and reversible adhesives. Furthermore, their formulations may be adjusted or fine-tuned for bonding a variety of adherends found in the semiconductor industry and microelectronic industry.

An adherend may be any solid material to which an adhesive adheres. There are many different kinds of adherend materials. Adherend materials almost include all known solids. Some interesting common adherend materials include woods, plastics, metals, ceramics, papers, cements, clothes, fabrics, silks, leathers, glasses, semiconductor materials (e.g., silicon wafers and chips), and microelectronic materials (e.g., read/write heads).

In some embodiments of this invention, the magneto-active adhesive systems of this invention are used to bond semiconductor and/or microelectronic components, such as silicon wafers, chips, and read/write heads, to a transporting and/or storing device, such as a matrix tray, a read/write head tray, a chip tray, a carrier tape, a carrier sheet, or a film frame. The above-mentioned trays or film frames may be made of materials selected from the group consisting of acrylonitrile-butadiene-styrene, polycarbonate, urethane, polyphenylene sulfide, polystyrene, polymethyl methacrylate, polyetherketone, polyetheretherketone, polyetherketoneketone, polyether imide, polysulfone, styrene acrylonitrile, polyethylene, polypropylene, fluoropolymer, polyolefin, nylon, and combinations thereof. The adhesive in the magneto-active adhesive system for these embodiments may be a thermoplastic vulcanizate material or a polymeric elastomer material having, a relatively soft surface, and ESD safe properties. Non-limiting examples of polymeric elastomer material include polyurethane, polybutylene terephthalate, polyolefins, polyethylene terephthalate, styrenic block co-polymers (e.g. Kraton®), styrene-butadiene rubber, and nylon in the form of polyether block polyamide. Non-limiting examples of thermoplastic vulcanizate material include polypropylene/crosslinked EDPM rubber, such as Santoprene® made by Advanced Elastomer Systems of Akron, Ohio.

The magneto-active adhesive systems for bond the semiconductor and/or microelectronic components to the transporting and/or storing device may have a surface energy between 20 dyne/cm and 100 dyne/cm, more preferably between about 30 dyne/centimeter to 45 dyne/centimeter, and most preferably about 40 dyne/centimeter. The surface electrical resistivity of the magneto-active adhesive systems may be between about 1×10⁴ ohms/square and 1×10¹² ohms/square. Optionally, an anti-static additive, such as conductive salts, carbon powders, carbon fibers, metallic particles, conductive polymers, and other electrically conductive fillers, may be added to the magneto-active adhesive system to achieve the desired surface electrical resistivity. Non-limiting examples of conductive polymers include doped polyaniline, polypyrrole, polythiophene, polyisothianaphthene, polyparaphenylene, polyparaphenylene vinylene, polyheptadiyne, and polyacetylene. Non-limiting examples of conductive salts include quaternary ammonium salts, sulfonium salts, alkyl sulfonates, alkyl sulfates, alkyl phosphates, ethanol amides, ethanol amines, or fatty amines. Any other method or material may be used for the purpose which provides the requisite electrical properties along with the desired surface energy.

The amount of adhesion provided by the magneto-active adhesive 22 system may be adjusted for particular applications. This adjustment may be accomplished by selecting the adhesive binder material used for the magneto-active adhesive system, or through alterations to the roughness, geometry and dimensions of the surface of the adherends. Furthermore, the adjustment may be achieved by adding to the magneto-active adhesive system additional additives, such as fillers, rheology modifiers, tackifiers, surfactants, dispersing agents, antioxidants, coupling agents, curing agents, and combinations thereof. Any of the additives mentioned-above may change the surface energy, the viscoelastic properties, or the relative hardness of the magneto-active adhesive system. Generally, it is desired that the magneto-active adhesive system can provide a degree of adhesion to a component per unit area of the component at least greater than the corresponding gravitational force per unit area of the component, thus permitting retention of the component even when the tray is inverted. It is most preferred that the amount of adhesion be sufficient to retain the components under shock and vibration loads typically encountered during shipping and handling operations.

Carriers are used in the micro-electronic industry for storing, transporting, fabricating, and generally holding small components such as, but not limited to, semi-conductor chips, ferrite heads, magnetic resonant read heads, thin film heads, bare dies, bump dies, substrates, optical devices, laser diodes, preforms, and miscellaneous mechanical articles such as springs and lenses.

In some embodiments, the present invention includes a carrier for handling semiconductor devices and other small components wherein the component has a surface area that can be placed into direct contact with a magneto-active adhesive contact surface on the carrier. The carrier is suitable for any type of component, including those having no projections or leads, such as bare or leadless chips, but may also be used with devices having leads such as Chip Scale Package (CSP) devices. The devices may be retained on the carrier without the use of lateral or vertical physical restraints apart from the magneto-active adhesive contact surface itself.

In some embodiments, one of the at least two adherends is a carrier in the form of a carrier tape or a film frame for storing and transporting electronic devices, such as integrated circuit chips, and the other adherends are the electronic devices. Carrier tapes having an adhesive tape are disclosed in U.S. Pat. Nos. 4,760,916 and 4,966,282, and some film frames having an adhesive layer are disclosed in U.S. Pat. No. 5,833,073. All of the above-mentioned patents are incorporated herein by reference. A magneto-active adhesive 22 may be applied as an outermost layer on the carrier tape or the film frame, which may or may not have an inner layer of another adhesive known in the art. The electronic devices are held to the carrier tape or the film frame by the magneto-active adhesive system when it is activated by applying or removing a magnetic field, depending on the composition of the magneto-active adhesive system. When the electronic devices need to be picked up manually or by a robot, the magneto-active adhesive system may be deactivated correspondingly by removing or applying a magnetic field.

An embodiment of a carrier tape with magneto-active adhesive is depicted in FIG. 13. Carrier tape 50 generally includes a body portion 52 made from generally flexible polymer material with a plurality of pockets 54 defined therein in a continuous sequence along the length of the tape 50. A continuous sequence of sprocket holes 56 is defined along one or both lateral margins 58, 60, of body 52 to enable tape 50 to be engaged and advanced by sprockets (not depicted) operated by process equipment (not depicted). According to the invention, a layer of magneto-active adhesive 22 is applied to the bottom of each pocket 54 to serve as a contact surface 62 for securing an article placed in pocket 54 in direct contact with contact surface 62. Although contact surface 62 is depicted in FIG. 13 as being flat, it will be appreciated that magneto-active adhesive 22 could be applied to a surface of any shape within pocket 54 to form a contact surface 62. Moreover, in carrier tape embodiments without pockets, it will be appreciated that magneto-active adhesive 22 could be applied to any structure on the carrier tape, such as a raised pedestal, to form a contact surface for securing an article.

In some embodiments, one of the adherends is a carrier in the form of a chip or matrix tray for storing and transporting microelectronic components, such as chips, other semiconductor devices, and read/write heads and the other adherends are the microelectronic components. Chip trays having an adhesive layer are disclosed in U.S. patent application Publication No. 2004/0047108, which is incorporated herein by reference. A magneto-active adhesive 22 is applied as an outermost layer on the chip tray, which may or may not have an inner layer of another adhesive known in the art. The microelectronic components are held to the chip tray by the magneto-active adhesive system when it is activated by applying or removing a magnetic field, depending on the composition of the magneto-active adhesive system. When the microelectronic components need to be picked up manually or by a robot, the magneto-active adhesive system may be deactivated correspondingly by removing or applying a magnetic field.

Matrix trays having an adhesive layer are disclosed in U.S. patent application Publication No. 2004/0048009, U.S. Pat. No. 5,481,438, and Japanese laid open patent application JP 05-335787, all of which are incorporated herein by reference. A magneto-active adhesive system is applied as an outermost layer on the matrix tray, which may or may not have an inner layer of another adhesive known in the art. The semiconductor devices are held to the read/write head tray by the magneto-active adhesive system when it is activated by applying or removing a magnetic field, depending on the composition of the magneto-active adhesive system. When the semiconductor devices need to be picked up manually or by a robot, the magneto-active adhesive system may be deactivated correspondingly by removing or applying a magnetic field.

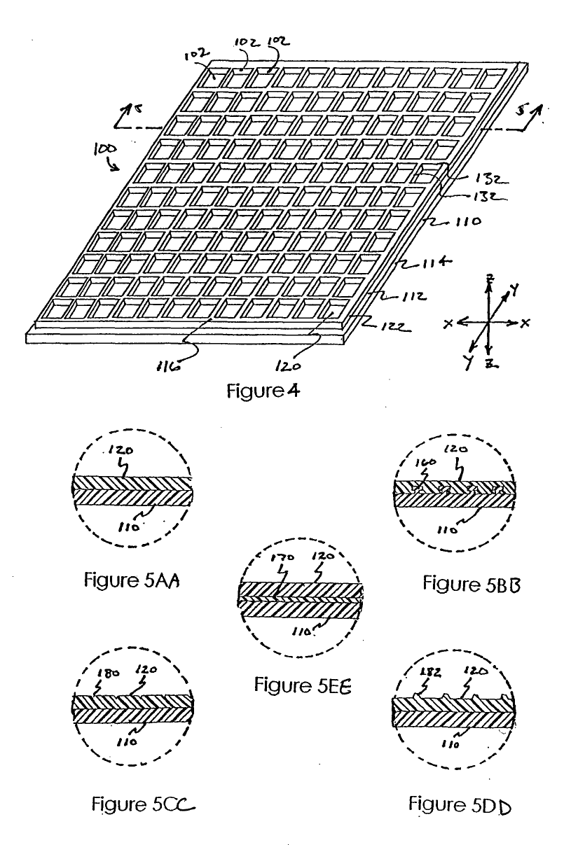

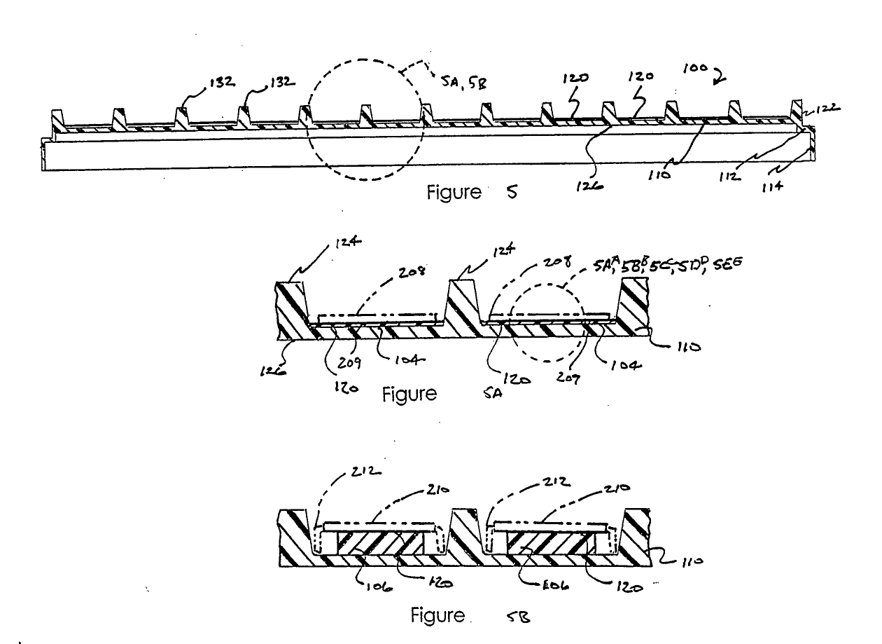

FIGS. 4 and 5 depict a preferred embodiment of a carrier according to the invention in the form of matrix tray 100. Tray 100 has rigid body portion 110 in which is formed a plurality of individual component receiving pockets 102 arranged in a matrix and oriented in a plane defined by the “x” and “y” axes as shown. Each pocket 102 has a depth dimension oriented in the “z” axis direction and contains at least one magneto-active adhesive component contact surface 120 for engaging and retaining a single component. Body portion 110 preferably has a peripheral border region 112 projecting laterally outward beyond the edge 122 of matrix portion 116. A downwardly projecting skirt 114 may be provided on body portion 110. The skirt 114 is positioned so as to engage the peripheral border region 112 of a tray located immediately below when multiple trays are stacked as depicted in FIG. 6. As an alternative to skirt 114, other structures such as downwardly projecting legs or posts may be used to facilitate stacking of multiple trays. It will be appreciated that although the pockets 102 are shown as being formed integrally in rigid body portion 110, other configurations wherein component receiving pockets or other structures are formed are contemplated and are within the scope of the invention. For example, the pocket defining cross members 132 may be formed in a separate grid work piece and attached to the remainder of rigid body portion 110 using adhesives, fasteners or other means.

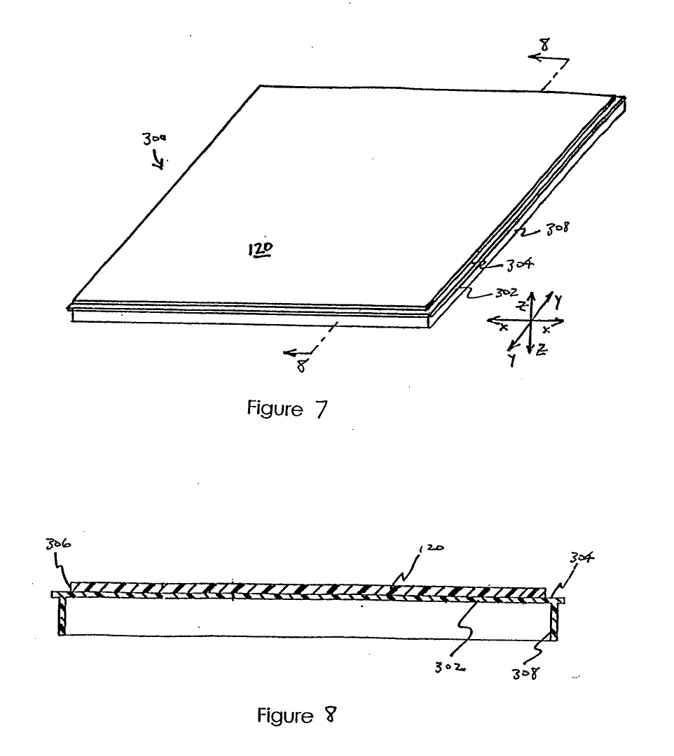

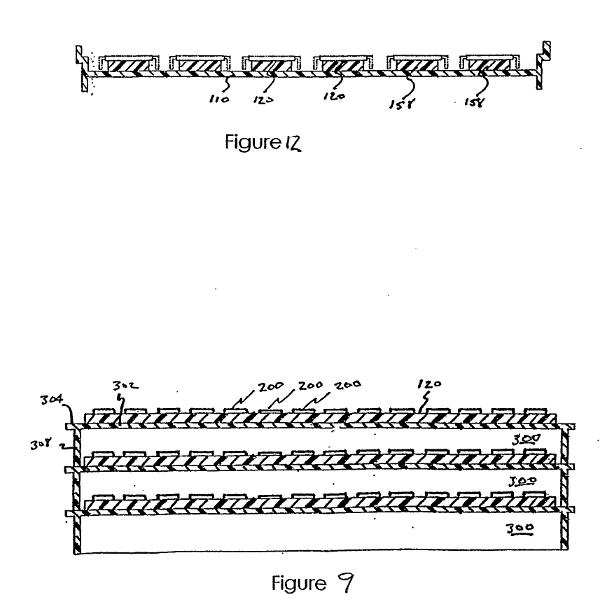

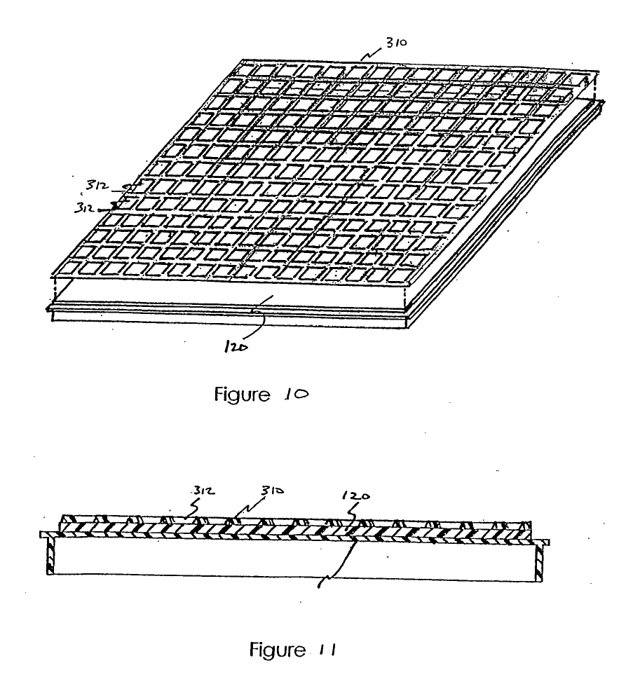

Another embodiment of a carrier 300 according to the present invention is depicted in FIGS. 7 and 8. In this embodiment without pockets, carrier 300 has a rigid body 302 oriented in a plane defined by the “x” and “y” axes as depicted. Rigid body 302 is overlain by magneto-active adhesive contact layer 120. Rigid body 302 preferably has a peripheral border region 304 projecting laterally outward beyond the edge 306 of contact layer 120. Body portion 302 may have a downwardly projecting skirt 308. Skirt 308 is positioned so as to engage peripheral border region 304 of another carrier 300 located immediately below when multiple carriers 300 are stacked as depicted in FIG. 9. As an alternative to skirt 308, other structures such as legs or posts may be similarly used to facilitate stacking of multiple carriers 300. Skirt 308 is of sufficient length so that any components 200 disposed on contact layer 120 do not contact any portion of the tray 300 stacked immediately above. Although not necessary for effective retention of components, a separate grid member 310 may be attached over contact layer 120 to define individual component retaining regions 312, as depicted in FIGS. 10 and 11.

The amount of adhesion provided by magneto-active adhesive 22 may be reduced by selectively altering the geometry and resulting amount of available component contact area of contact surface 120. This may be accomplished by forming a multiplicity of regular depressions 180 or projections 182 in contact surface 120 as shown in greatly exaggerated fashion for clarity in FIG. 5CC or 5DD, respectively. The depressions 180 or projections 182 may be arranged randomly or in a regular matrix pattern on contact surface 120. The depressions 180 or projections 182 may be from about 0.000040 inch to 0.10 inch in depth or height respectively, and spaced from about 0.000040 inch to about 0.30 inch apart, as may be needed to achieve the desired amount of adhesion. The features may be formed on contact surface 120 by stamping with a mold machined with a negative impression of the desired features. Generally, the mold may be machined using known machining techniques. Photolithography may be used to machine the mold to form regular features at the smaller ends of the ranges. As an alternative, a mold having a fine, random distribution of features may be made by sandblasting, glass beading, or shotpeening the mold surface.

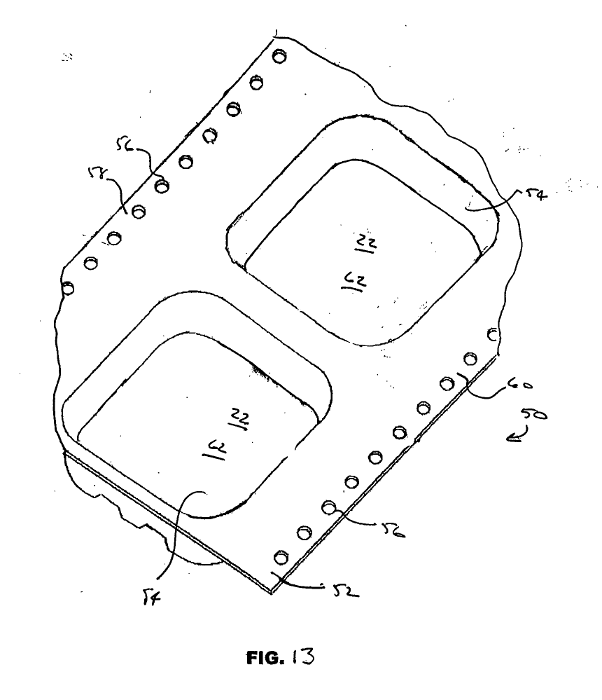

One preferred embodiment of a matrix tray, suitable for bare or leadless devices 208, is shown in FIG. 5A. The contact surface 120 is molded over the bottom 104 of each pocket 102 in a continuous layer. As may be seen, a device 208 has a surface 209 in direct contact with contact surface 120. Device 208 is retained in place by adhesion between surface 209 and contact surface 120 exclusively. As depicted, body portion 110 is not in direct contact with device 208 and does not constrain the device. Another embodiment shown in FIG. 5B has contact surface 120 formed as a part of a raised structure 106 within the pocket 102. As illustrated, this structure is particularly suitable for certain types of components 210 having projecting leads 212. It will be appreciated that the invention may include any pocket configuration or structure wherein a magneto-active adhesive contact surface having the requisite properties is presented that can be placed into contact with the surface of a device. For instance, as shown in FIG. 12, the tray may include a matrix of platform structures 158 raised above the surface of the body portion of the tray 110 in place of recessed pockets. Contact surface 120 is provided at the top of each structure 158.

Contact surface 120 may be injection overmolded using standard injection molding techniques. Preferably, the materials for surface layer 120 and body portion 110 are selected so that a polar bond is formed during the injection molding process. The two layers may also be mechanically fastened together, or may be secured by a combination of methods. In addition, mechanical bonding structures 160, as shown best in FIG. 5BB, may be provided on body portion 110 to enhance bonding efficacy. In addition, an intermediate or tie layer 170 may be used between the two materials to enhance bonding effectiveness as shown in FIG. 5EE. It is preferred that thermoplastic polymers be used for body portion 110, since thermoplastics tend to offer the general advantages of easier recyclability, greater purity with a smaller process contamination causing sol-fraction, and lower cost. Body portion 110 may be made ESD safe using materials and techniques known in the art. Suitable rigid thermosetting polymers may also be used for body portion 110, but are less preferred.

As understood by those skilled in the art, additional variations of the chemical compositions, and alternative methods of making and using of the magneto-active adhesive systems may be practiced within the scope and intent of the present disclosure of the invention. The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention. Furthermore, this invention may be applied in many other industries and is not limited to only semiconductor industry and microelectronic industries.

1. A method of adhesive bonding by magnetic field, comprising the steps of:
(a) providing at least two adherends to be bonded;
(b) providing a magneto-active adhesive system between the at least two adherends, the magneto-active adhesive system comprising a plurality of magnetic particles and an adhesive; and
(c) applying a non-cyclically varying magnetic field or a cyclically varying magnetic field induced by an alternating current having a frequency of less than 100 hz to the magneto-active adhesive system to change the adhesion of the magneto-active adhesive system to at least one of the adherends.

2. The method of claim 1, further including the step of selecting one of the adherends from the group consisting of a matrix tray, a read/write head tray, a chip tray, a carrier tape, a carrier sheet, and a film frame.

3. A magneto-active adhesive system comprising:
a pair of adherends;
a layer of magneto-active adhesive confronting each of the adherends, the magneto-active adhesive comprising a-multiplicity of magnetic particles in an adhesive binder; and
means for activating the magneto-active adhesive to adhere the adherends together.

4. The system of claim 3, wherein one of the adherends comprises a plurality of semiconductor components, microelectronic components, or combinations thereof, and the other of the pair of adherends is selected from the group consisting of a matrix tray, a read/write head tray, a chip tray, a carrier tape, a carrier sheet, and a film frame.

5. The system of claim 4, wherein at least one of the adherends is made of a material selected from the group consisting of acrylonitrile-butadiene-styrene, polycarbonate, urethane, polyphenylene sulfide, polystyrene, polymethyl methacrylate, polyetherketone, polyetheretherketone, polyetherketoneketone, polyether imide, polysulfone, styrene acrylonitrile, polyethylene, polypropylene, fluoropolymer, polyolefin, nylon, and combinations thereof.

6. The system of claim 3, wherein the magneto-active adhesive includes a carrier fluid, the carrier fluid and the multiplicity of magnetic particles together constituting a magnetorheological fluid.

7. The system of claim 6, wherein the number average particle size of the magnetic particles is between 0.1 and 1000 microns.

8. The system of claim 3, wherein the magneto-active adhesive includes a carrier fluid and the adhesive binder includes a cross-linked polymer network, the carrier fluid, the adhesive, and the plurality of magnetic particles together constituting a ferrogel.

9. The system of claim 7 wherein the number average particle size of the magnetic particles is between about 1 and 1000 nm.

10. The system of claim 3, wherein the magnetic particles comprise magnetocaloric particles.

11. The system of claim 10 wherein the magnetocaloric particles are selected from the group consisting of Gd, Gd₅Si₂Ge₂, MnAs, La(Fe_{0.88}Si_{0.12})₁₃, and La(Fe_{0.88}Si_{0.12})₁₃H_{1.0} particles.

12. The system of claim 3, wherein the magnetic particles comprise magnetic inductive particles and the adhesive binder comprises a shape-memory polymer.

13. A carrier for a microelectronic component comprising:
a body portion made from plastic material; and
an magneto-active adhesive component contact surface comprising a layer of magneto-active adhesive on the body portion for retaining the microelectronic component on the carrier.

14. The carrier of claim 13, wherein the magneto-active adhesive comprises a multiplicity of magnetic particles in an adhesive binder.

15. The carrier of claim 14, wherein the magneto-active adhesive comprises magnetorheological fluid.

16. The carrier of claim 14, wherein the magneto-active adhesive comprises a ferrogel.

17. The carrier of claim 14, wherein the magneto-active adhesive includes magnetocaloric particles.

18. The carrier of claim 14, wherein the magneto-active adhesive comprises a crystallizable polymeric adhesive.

19. The carrier of claim 14, wherein the magneto-active adhesive comprises a shape-memory polymer.

20. The carrier of claim 14, wherein the magneto-active adhesive comprises a mulitplicity of encapsulated magnetic particles.
